(19) United States
(12) Patent Application Publication
(10) Pub. No.: US 2011/0033590 A1
(43) Pub. Date: Feb. 10, 2011

(54) Apparatus and Method for Reprocessing Tea Leaves

(76) Inventor: Nikhil Joshi, Maharastra (IN)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(21) Appl. No.: 12/866,979

(22) PCT Filed: Nov. 10, 2008
(86) PCT No.: PCT/IN08/00762

§ 371 Date: Oct. 28, 2010

(30) Foreign Application Priority Data
Feb. 12, 2008 (IN) 295/MUM/2008

(51) Int. Cl. A23F 3/06

(52) U.S. Cl. 426/242; 99/451

(57) ABSTRACT

An apparatus for reprocessing tealeaves comprising a Mixer; a motor or hopper to run the mixer; a funnel attached to the mixer for adding the tealeaves in the mixer; a fan blender; a conveyor belt; a motor to run the conveyor belt; an infrared system and chamber; a microwave chamber; a swing type shielded doors on both ends of the microwave chamber; a vacuum packaging machine; a glass casing for housing the conveyor belt, infrared red chamber, microwave chamber and vacuum packaging; Controller power unit; supporting and storage frame; wherein the conveyor belt, is affixed laterally on the supporting frame with one side of the supporting frame supporting a wall on which the funnel, mixer, blender and motor/hopper are mounted; and the other side of the supporting frame is attached to the vacuum packaging machine; and whereas the infrared chamber and microwave chamber are mounted on top of the conveyor belt; and whereas the conveyor belt, infrared chamber and microwave chamber and the vacuum packaging machine are all encased in a glass casing; and wherein the tealeaves of the desired quantity are passed from the motor/hopper, which then pass through the fan blender and fall onto the conveyer belt; and the said tealeaves first pass through the infrared chamber and then pass through the microwave chamber and thereafter automatically vacuum packaged in the vacuum packaging machine without any intervention from outside the apparatus or human or manual intervention at the end of the conveyor belt, whereas the above stated arrangement is encased in a glass chamber and rests on a supporting frame which houses the controller power and also serves as storage space for the reprocessed packaged tealeaves.

### CROSS REFERENCE TO RELATED APPLICATION

This application is claims priority to each of the following applications: (1) Patent Cooperation Treaty Application PCT/IN2008/000762, filed Nov. 10, 2008; and (2) Indian Patent Application 296/MUM/2008, filed Feb. 12, 2008, each of the above cited applications is hereby incorporated by reference herein as if fully set forth in its entirety.

### FIELD OF INVENTION

This invention relates to an apparatus and a method of refreshing and re-processing tealeaves and other agricultural products such as herbs, spices, coffee etc., to make them moisture-free. More particularly, this invention provides an apparatus and a method of re-processing tealeaves and other agricultural products such as herbs, spices, coffee etc., moisture-free or nearly moisture-free using a specialized mechanical process for moisture removal/reduction.

### BACKGROUND OF THE INVENTION

Agricultural products such as tealeaves, herbs, spices, coffee etc., are practically used everyday by everyone in the world. With a particular reference to tea, tea is one of the most popular beverages around the world. For centuries, tea has been consumed around the world. Tea is consumed for different reasons such as medicinal, to keep warm or simply because of the taste. The value and quality of the tea, such as flavour, aroma, taste, medicinal properties, depends essentially upon the quality of the tealeaves. The quality of the tealeaves, in turn, depends upon the freshness of the tealeaves. Fresher the tea leaves, better the quality of the tea. After the tealeaves are plucked from the tea gardens, the tealeaves are dried, processed and packed to be transported and sold. During these processes, tealeaves absorb moisture from the atmosphere. This absorption of moisture from the atmosphere results in tealeaves losing their qualities of fragrances, flavour, aroma, taste, medicinal value etc. Therefore, for the tealeaves to be fresh and to retain their best qualities, the tealeaves have to be made as completely moisture free before packing Therefore, the best way of ensuring that the tealeaves retain their best qualities i.e., original tea flavour is to ensure that the tealeaves are completely dry or almost moisture free before packing these tealeaves in packages. This subsequent packaging will be effective only if the tealeaves are completely dry or almost free from moisture content. Attempts have been made in the past to keep tealeaves as dry or moisture free as possible before they are packed. These attempts have met with moderate success.

To mitigate and address this problem, in the past, different methods for drying tealeaves have been used. These methods are such as drying the tealeaves in the sun or in the ovens or kilns or simple mechanical devices for heating the tealeaves. However, these methods have drawbacks such as open environment, uncontrolled heating, variable weather conditions, too much reliance upon skills of individuals involved in the process of drying the tealeaves, not to mention the time and money spent on training these individuals; dust and impurities from atmosphere, oven and kilns, high maintenance costs of keeping the kilns and ovens clean, usage of natural resources and fossil fuels to fire these ovens and kilns. Most of the methods used in the past are manual or at the most semi-automatic and, therefore, constant supervision and care is required while the process is being carried out.

Above-stated are some of the disadvantages of the presently existing methods for drying the tealeaves. These factors result lowering the qualities of the tealeaves in terms of fragrances, flavour, aroma, taste, medicinal value etc. This is also not good from the storage point of view, since the shelf life of the packaged tealeaves also is reduced. Thus, there has been a long felt need of an apparatus and method of reprocessing and refreshing tealeaves without any of the above-stated problems that is easy to implement, ergonomical, economical, convenient and practical. The present invention is directed towards overcoming one or more of the problems discussed above.

### SUMMARY OF THE INVENTION

According to the first aspect of the present invention, there is provided an apparatus comprising:

a Mixer; a motor or hopper to run the mixer; a funnel attached to the mixer for adding the tealeaves in the mixer; a fan blender; a conveyor belt; a motor to run the conveyor belt; an infrared system and chamber; a Microwave chamber; swing type shielded doors on both ends of the microwave chamber; a vacuum packaging machine; a glass casing for housing the conveyor belt, infrared red chamber, microwave chamber and vacuum packaging; controller power; supporting and storage frame;

wherein the conveyor belt, is affixed laterally on the supporting frame with one side of the supporting frame supporting a wall on which the funnel, mixer, blender and motor/hopper are mounted; and the other side of the supporting frame is attached to the vacuum packaging machine; and whereas the infrared chamber and microwave chamber are mounted on top of the conveyor belt; and whereas the conveyor belt, infrared chamber and microwave chamber and the vacuum packaging machine are all encased in a glass casing; and wherein the tealeaves of the desired quantity are passed from the motor/hopper, which then pass through the fan blender and fall onto the conveyer belt; and the said tealeaves first pass through the infrared chamber and then pass through the microwave chamber and thereafter automatically vacuum packaged in the vacuum packaging machine without any intervention from outside the apparatus or human or manual intervention at the end of the conveyor belt, whereas the above stated arrangement is encased in a glass chamber and rests on a supporting frame which houses the controller power and also serves as storage space for the reprocessed packaged tealeaves.

Preferably, the motor or hopper is mechanically powered. This arrangement makes it convenient to use any motor for the purpose of mixing the tealeaves in the mixer.

Preferably, the motor for running the conveyor belt is of 0.5 horsepower and 415 volt.

Preferably, the conveyor belt is Teflon coated. This coating ensures that the tea leaves that fall on conveyor belt do not stick to the conveyor belt and thereby result in the loss of tealeaves.

Preferably, the Teflon coated belt moves at a speed of 5 to 6 meters per minute. This speed optimizes and is convenient for the transfer of tealeaves that ensures that the tealeaves do not fly off the conveyor belt.

Preferably, the height of the heap of tealeaves when dropped on the conveyor belt from the mixer is not higher than two millimeter. This ensures that right amount of tealeaves are collected on the conveyor belt for the maximum and the most effective drying of tealeaves.

Preferably, the infrared system is four ceramic coil type infrared systems.

Preferably, each of the four ceramic coil type infrared systems is of 500 Watts. This arrangement has the advantage to obtain the best drying of the tealeaves.

Preferably, the temperature in the Infrared chamber is maintained between 80° C.-100° C. This arrangement facilitates the faster and proper drying of tealeaves without burning or singing the tealeaves.

Preferably, the microwave chamber is fixed after the infrared heating chamber.

Preferably, the microwave chamber's power supply comprises of magnetron with temperature sensor cooling fan, waveguide, high voltage transformer, F.T. transformer and a control card.

Preferably, the microwave chamber has swing type shield doors at both ends of the microwave chamber. This arrangement has the advantage of allowing the smooth entry and exit of the tealeaves already dried in the infrared chamber.

Preferably, the swing type shielded doors at both ends of microwave chamber are made of material which is non-stick. This arrangement is helpful in ensuring that the tealeaves do not stick to the swing type shielded doors.

Preferably, the swing type shielded doors at both ends of microwave chamber are made of material which preserves heat inside the chamber after swinging back in position. This arrangement ensures that the heat is preserved inside the infrared chamber for maximum and complete drying of tealeaves.

Preferably, the re-processed tealeaves are then automatically vacuum packaged without any intervention from outside the apparatus or human or manual intervention at the end of the conveyor belt. The arrangement has the advantage that the reprocessed tealeaves are not subjected to outside environment and are packaged within the apparatus, thereby reducing any chances of the reprocessed tealeaves absorbing moisture from the atmosphere.

Preferably, the re-processed and packaged tealeaves are stored in the storage space provided in the supporting frame.

Preferably, the storage frame is made of a sturdy and water resistant material.

Preferably, the time for re-processing the tealeaves is approximately two minutes.

Preferably, the controlling power unit provides power for running the motor mixer, the conveyer bet, infrared chamber and microwave chamber

### BRIEF DESCRIPTION OF THE DRAWINGS

The present invention will now be described by way of examples with reference to the accompanying drawings wherein:

FIG. 1 illustrates the schematic layout of the tealeaves re-processing apparatus;

FIG. 2 illustrates perspective view of the tealeaves re-processing apparatus;

FIG. 3 illustrates the close-up view of the infrared chamber of the tealeaves re-processing apparatus

FIG. 4 illustrates the close-up view of the microwave chamber tealeaves re-processing apparatus

### DETAILED DESCRIPTION OF THE INVENTION

The present embodiments represent the best ways known to the applicants of putting the invention into practice. But they are not the only ways in which this can be achieved. They are illustrated, and they will now be described, by way of examples only.

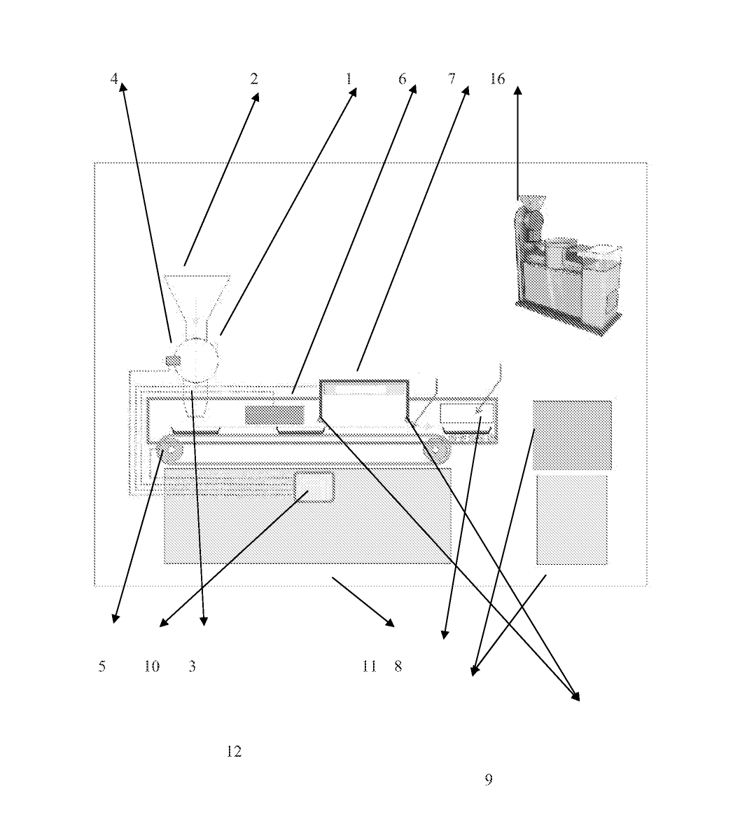

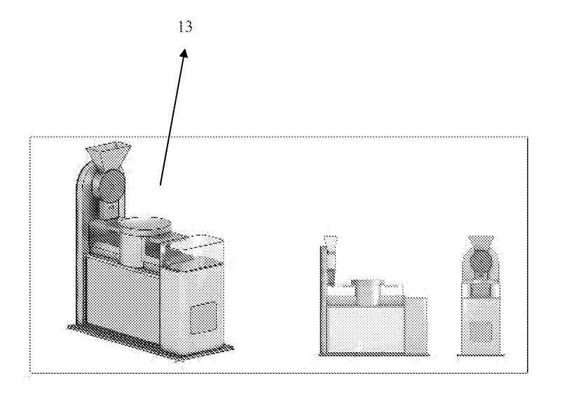

FIGS. 1 and 2 show the apparatus (15) according to one embodiment of this present invention comprising of mixer (1) powered by a motor (4) attached to a funnel (2) on top of the mixer (1) and a lower end (3) of the mixer (1) entering into a glass casing (13) wherein the mixer (1) and one end of glass casing (13) is mounted on to a wall (16). The wall (16) extends all the way down to the base (17) and one end of the wall supports the support frame (11). The wall (16), the base (17) and the supporting frame (11) are all made of durable material which is resistant to the surrounding atmosphere. In particular, this durable material does not allow moisture to seep into the apparatus from the surrounding atmosphere and environment. The other end of the supporting frame (11) has the vacuum packaging machine (12) mounted in such a manner that there is no gap or cavity for air to seep into the apparatus (15). A conveyer belt (5) is mounted on top of the supporting frame (11). The length of the conveyer belt (5) is roughly the same length of the top of the supporting frame (11). The conveyer belt (5) is mounted on the supporting frame (11) according to the standard manner of mounting conveyer belts on such a supporting frame. The conveyer belt (5) is powered by a central power control unit (10). This central power control unit (10) is housed inside the supporting frame (11). To house and keep the central power control unit (10) safe and secure, there is a platform made inside the supporting frame (11). This platform also separates the storage area from the central power control unit (10) ensuring that the stored reprocessed tealeaves are not damaged or affected in any way. In a preferred embodiment, the mixer (1), an infrared chamber (6), a microwave chamber (7) and the vacuum packaging unit (12) are arranged in one line and this whole arrangement is encased in glass casing (13). This does mean that the said components cannot be arranged in a straight line. The infrared chamber (6) is mounted in such a way that the upper wall of the infrared chamber (6) is parallel or almost parallel to the conveyer belt (5) and the sides of the infrared chamber (6) are substantially perpendicular to the conveyer belt (5). The infrared chamber (6) is mounted in the glass casing (13) in such a way that there is no seepage of air or water from the surrounding environment. After the infrared chamber (6), the microwave chamber (7) is mounted in the glass casing in such a way that the upper wall of the microwave chamber (7) is parallel or almost parallel to the conveyer belt (5) and the sides of the microwave chamber (7) are substantially perpendicular to the conveyer belt (5). The microwave chamber (7) is mounted in the glass casing (13) in such a way that there is no seepage of air or water from the surrounding environment. In a preferred form, the infrared chamber (6) and the microwave chamber (7) are housed in one cylindrical shell and this cylindrical shell is then mounted between the glass casing (13) ensuring that there is no seepage of air or water from the surrounding atmosphere. It is not necessary that the housing for infrared chamber (6) and the microwave chamber (7) has to be cylindrical. The housing can be of any geometrical shape. It is preferred, although not essential in all cases that the top of the glass casing (13) has to be made of glass. The top of the glass casing (13) can also be made of any material as long as such material is resistant to environment outside the apparatus (15) and provides maximum stability to the apparatus. This material also should be able to sustain the heat that is generated inside the casing. In a preferred embodiment, the microwave chamber (7) has two swing type shielded doors (9) on both ends of the microwave chamber. These are the ends from where the conveyer belt (5) is moving into the microwave chamber (7). The swing type shielded doors (9) extend downwards towards the conveyer belt and are attached to the ends of the microwave chamber (7) by way of hinges. The swing type shielded doors (9) are such that even slight pressure pushes them inwards or outwards depending upon from which end the pressure is being applied. A close up view of the swing doors is available in FIG. 4. In one of the embodiments, the vacuum packaging unit (12) is mounted on the opposite end of the wall (16). This vacuum packaging unit (12) operates automatically by collecting the reprocessed and dried tealeaves, coming on the conveyer belt (5) through the treatment in the mixer (1), infrared chamber (6) and microwave chamber (7), packaging the tealeaves in bags in an air free atmosphere and dropping the packed down a chute in the vacuum packaging unit (12). The vacuum packaging unit (12) may be in the same glass casing that covers the apparatus or vacuum packaging unit (12) may have separate glass casing. In both the embodiments, it is an essential feature of the invention that the glass casing does not allow air and water to let inside the apparatus. The central power unit (10) provides power for the motor (4), conveyer belt (5), infrared chamber (6) and the microwave chamber (7). This central power unit (10) can be connected to any power source not limited to regular power supply, generators or auxiliary power support systems. The process for drying and re-processing tealeaves using the apparatus comprises of the tealeaves being dispensed from the mixer (1) on to the conveyer belt (5) moving at a speed of 5 to 6 meters per minute and the tealeaves form a heap on the conveyer belt (5) of the height of approximately 2 millimeter. The heap of tealeaves of this height is the optimum amount to obtain the best results of drying the tealeaves or to attain the complete exposure for drying. The heap of tealeaves does not become bigger because of the constant movement of the conveyor belt (5). The conveyer belt (5) then takes this heap of tealeaves through the infrared chamber (6) for the first leg of drying and then the conveyer belt (5) carries the tealeaves through the first swing shield door (9) in the microwave chamber (7) and out of the second swing shield door (9) into the vacuum packaging unit (12). Once the tealeaves are packed in the vacuum packaging unit (12), they are dropped into the storage area under the vacuum packaging unit (12) and can be collected from the cavity (14) in the vacuum packaging unit. This cavity (14) may or may not be covered with a door. In the preferred embodiment, the measurements of the apparatus are 1450 mm in length, 1550 mm in height and 530 mm in breadth. This does not mean that the apparatus cannot be larger or smaller then these measurements. In summary, the present invention provides new apparatus for re-processing and freshening of tealeaves.

There are several advantages of the present invention. These include:

Firstly, the apparatus improves aroma and brings freshness in tea leaves through a moisture reduction apparatus and process. Secondly, the re-processed tealeaves through this apparatus have longer shelf life as compared to packaged tealeaves without going through this process since any additional moisture is removed during the process.

Thirdly, is that while the moisture is removed from the tealeaves by the apparatus and the process used, the original flavour of the tea is maintained. Fourthly, this apparatus, in addition to tealeaves, can also be used for other agricultural products such as herbs, spices, coffee etc.

Fifthly, the apparatus is small and portable ensuring that very little space is occupied by the apparatus. Sixthly, the apparatus being small, is more maneuverable. Seventhly, the apparatus and the process described hereinabove take approximately two minutes for reprocessing the tealeaves depending on quantity of product and amount of moisture content in the product.

Although, the invention has been described with reference to specific examples, it would be appreciated by those skilled in the art that the invention may be embodied in many forms. Preferred embodiments of this invention been described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. An apparatus and method for re-processing tealeaves comprising: a Mixer; a motor or hopper to run the mixer; a funnel attached to the mixer for adding the tealeaves in the mixer; a fan blender; a conveyor belt; a motor to run the conveyor belt; an infrared system and chamber; a Microwave chamber; swing type shielded doors on both ends of the microwave chamber; a vacuum packaging machine; a glass casing for housing the conveyor belt, infrared red chamber, microwave chamber and vacuum packaging; controller power; supporting and storage frame; wherein the conveyor belt, is affixed laterally on the supporting frame with one side of the supporting frame supporting a wall on which the funnel, mixer, blender and motor/hopper are mounted; and the other side of the supporting frame is attached to the vacuum packaging machine; and whereas the infrared chamber and microwave chamber are mounted on top of the conveyor belt; and whereas the conveyor belt, infrared chamber and microwave chamber and the vacuum packaging machine are all encased in a glass casing; and wherein the tealeaves of the desired quantity are passed from the motor/hopper, which then pass through the fan blender and fall onto the conveyer belt; and the said tealeaves first pass through the infrared chamber and then pass through the microwave chamber and thereafter automatically vacuum packaged in the vacuum packaging machine without any intervention from outside the apparatus or human or manual intervention at the end of the conveyor belt, whereas the above stated arrangement is encased in a glass chamber and rests on a supporting frame which houses the controller power and also serves as storage space for the reprocessed packaged tealeaves.

2. The apparatus as claimed in claim 1 wherein the motor or hopper is mechanically powered.

3. The apparatus as claimed in claim 1 wherein the motor for running the conveyor belt is of 0.5 horsepower and 415 volt.

4. The apparatus as claimed in claim 1 wherein the conveyor belt is Teflon coated.

5. The apparatus as claimed in claim 1 wherein the Teflon coated belt moves at a speed of 5 to 6 meters per minute.

6. The apparatus as claimed in claim 1 wherein the height of the heap of tealeaves when dropped on the conveyor belt from the mixer is not higher than two millimeter.

7. The apparatus as claimed in claim 1 wherein the infrared system is four ceramic coil type infrared systems.

8. The apparatus as claimed in claim 1 wherein each of the four ceramic coil type infrared systems is of 500 Watts.

9. The apparatus as claimed in claim 1 wherein temperature in the Infrared chamber is maintained between 80° C.-100° C.

10. The apparatus as claimed in claim 1 wherein the microwave chamber's power supply comprises of magnetron with temperature sensor cooling fan, waveguide, high voltage transformer, F.T. transformer and a control card.

11. The apparatus as claimed in claim 1 wherein the microwave chamber has swing type shield doors at both ends of the microwave chamber.

12. The apparatus as claimed in claims 1 wherein the swing type shielded doors at both ends of microwave chamber are made of material which is non-stick.

13. The apparatus as claimed in claims 1 wherein the swing type shielded doors at both ends of microwave chamber are made of material which preserves heat inside the chamber after swinging back in position.

14. The apparatus as claimed in claim 1 wherein the reprocessed and packaged tealeaves are stored in the storage space provided in the supporting frame.

15. The apparatus as claimed in claim 1 wherein the time for reprocessing the tealeaves is approximately two minutes.

16. The apparatus as claimed in claim 4 wherein the Teflon coated belt moves at a speed of 5 to 6 meters per minute.

17. The apparatus as claimed in claim 10 wherein the microwave chamber has swing type shield doors at both ends of the microwave chamber.

18. The apparatus as claimed in claims 17 wherein the swing type shielded doors at both ends of microwave chamber are made of material which is non-stick.

19. The apparatus as claimed in claims 18 wherein the swing type shielded doors at both ends of microwave chamber are made of material which preserves heat inside the chamber after swinging back in position.
